(19) United States
(12) Patent Application Publication
(10) Pub. No.: US 2005/0071775 A1
(43) Pub. Date: Mar. 31, 2005

(54) Data processing apparatus and display control method

(76) Inventor: Satoshi Kaneko, Iruma-gun (JP)

Correspondence Address: Finnegan, Henderson, Farabow,;Garrett & Dunner, L.L.P., 1300 I Street, N.W., Washington, DC, 20005-3315, US

(21) Appl. No.: 10/920,396

(22) Filed: Aug. 18, 2004

(30) Foreign Application Priority Data
Aug. 20, 2003 (JP) 2003-296588

(51) Int. Cl. G06F 3/00; G09G 5/00

(52) U.S. Cl. 715/801; 715/802; 715/803

(57) ABSTRACT

A data processing apparatus comprises an operation member which is operated to change a display form of displayed contents and a processing unit which is responsive to an operation of the operation member to change the display form of the displayed contents of an active window.

### CROSS-REFERENCE TO RELATED APPLICATIONS

This application is based upon and claims the benefit of priority from prior Japanese Patent Application No. 2003-296588, filed Aug. 20, 2003, the entire contents of which are incorporated herein by reference.

### BACKGROUND OF THE INVENTION

1. Field of the Invention

The present invention relates to a data processing apparatus equipped with an operating device and a display device and a display control method for the data processing apparatus.

2. Description of the Related Art

An example of a utility program that is adapted to enlarge or reduce on-screen images is one that is capable of enlarging or reducing user interface components, such as icons, toolbar options, pull-down menus, etc., when a mouse is clicked (for example, Liquid View (trade name) by Portrait Display Company).

Such a conventional type of utility program is set to enlarge or reduce each of the components in the user interface at the same time. Therefore, a problem arises in that even components the user does not intend enlarging or reducing are enlarged or reduced. In addition, objects for enlargement or reduction are the frames and titles of windows. That is, images within the windows are displayed without being enlarged or reduced. The utility program is therefore not so convenient.

### BRIEF SUMMARY OF THE INVENTION

According to an embodiment of the present invention, a data processing apparatus comprises an operation member which is operated to change a display form of displayed contents, and a processing unit which is responsive to an operation of the operation member to change the display form of the displayed contents of an active window.

According to another embodiment of the present invention, a data processing apparatus comprises a display unit having a screen capable of displaying windows, an operation member which is operated to change a display form, and a processing unit which is responsive to an operation of the operation member to search through the windows displayed on the screen for a window in an active state and changes the display form of displayed contents of the searched window.

According to still another embodiment of the present invention, a data processing apparatus comprises a display unit on which an image of a desktop appears, an operation member which is operated to change the display form of the image of the desktop, and a processing unit which is responsive to an operation of the operation member to change the display form of the image of the desktop.

According to still another embodiment of the present invention, a display control method comprises obtaining an event associated with an operation on an operation member assigned a predetermined function, detecting an active window in accordance with the obtained event, identifying an application from the class name or the window name including the class name of the detected window, making a decision of whether or not the identified application is capable of carrying out a function corresponding to the obtained event, and carrying out that function when the decision is that the identified application is capable of carrying out that function.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram of a first embodiment of the data processing apparatus according to the present invention;

FIG. 2 is a perspective exterior view of the data processing apparatus shown in FIG. 1;

FIG. 3 shows exemplary contents of an application reference table (TBL-A) within a memory of FIG. 1;

FIG. 4 shows exemplary contents of a property setting table (TBL-B) associated with a zooming utility program within the memory of FIG. 1;

FIG. 5 shows exemplary contents of a zooming process activation table (TBL-C) within the memory of FIG. 1;

FIG. 6 is a flowchart for the procedure of a zooming utility program (ZUP) within the memory of FIG. 1;

FIGS. 7A and 7B are diagrams for use in explanation of a zooming process of enlarging display contents of an active window;

FIGS. 8A and 8B are diagrams for use in explanation of a zooming process of reducing display contents of the active window;

FIGS. 9A and 9B are diagrams for use in explanation of a zooming process of enlarging icons on a desktop;

FIGS. 10A and 10B are diagrams for use in explanation of a zooming process of reducing icons on an image of the desktop;

FIG. 11 shows a modification of an operation member in the data processing apparatus; and

FIG. 12 shows another modification of the operation member in the data processing apparatus.

### DETAILED DESCRIPTION OF THE INVENTION

An embodiment of a data processing apparatus according to the present invention will now be described with reference to the accompanying drawings.

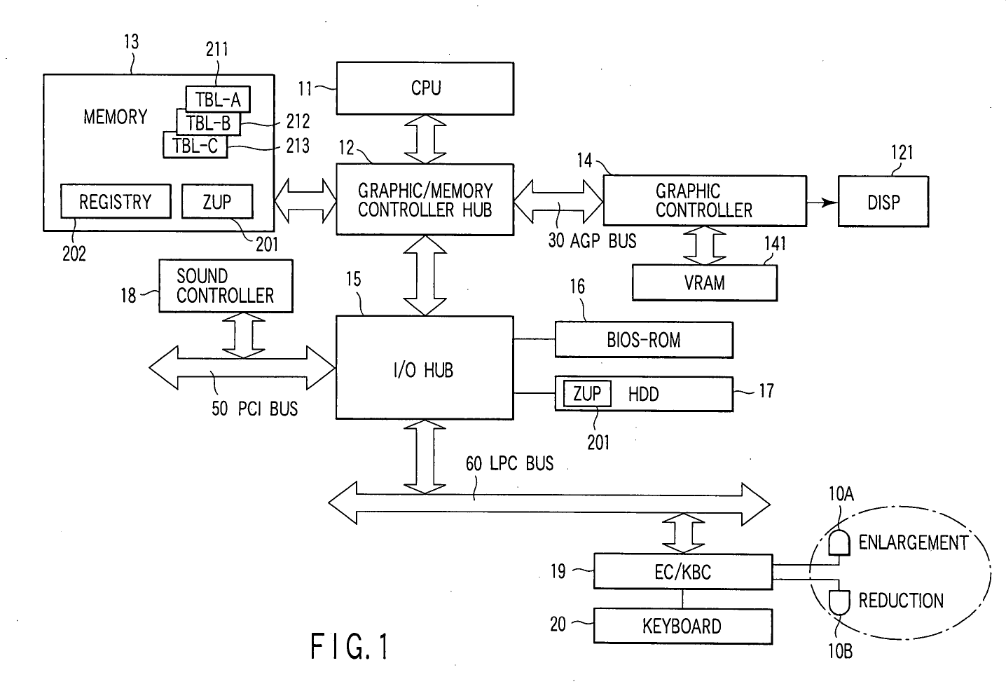

FIG. 1 illustrates the configuration of the data processing apparatus according to the embodiment. Here, as an example, the system configuration of a battery-powered notebook personal computer is illustrated.

This computer system includes a CPU 11, a graphics/memory controller hub 12, a memory (main memory) 13, a graphics controller 14, a video RAM (VRAM) 141, an I/O hub 15, a BIOS-ROM 16, a hard disk drive (HDD) 17, a sound controller 18, a keyboard/embedded controller (EC/KBC) 19, a keyboard 20, a display device (DISP) 121.

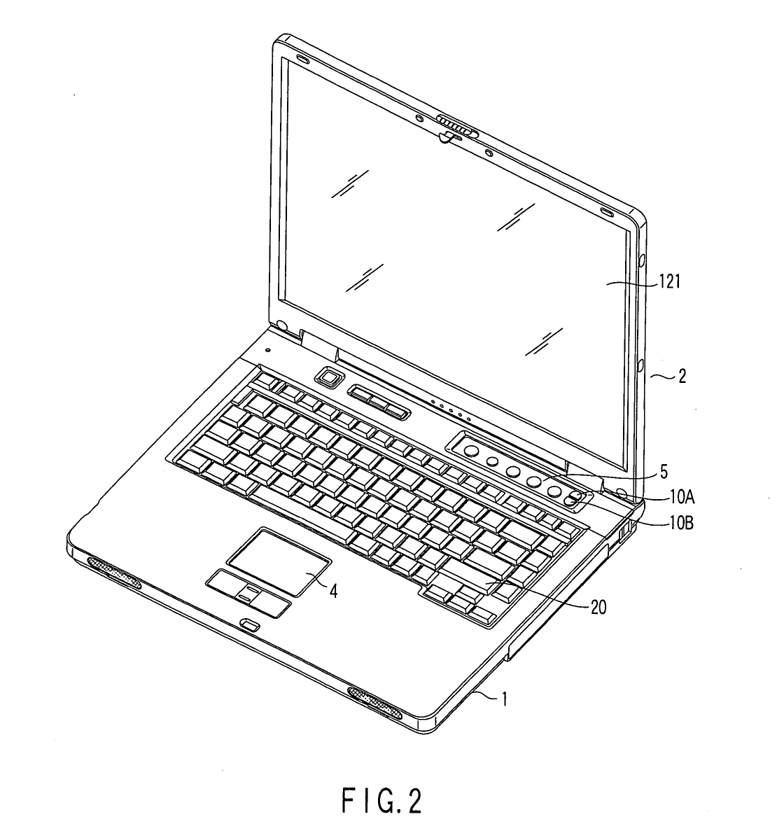

As user's operation member, in addition to the keyboard 20 and pointing devices such as a mouse, a touch panel, etc., dedicated buttons 10A and 10B that are operated to change the display form are provided (see FIG. 2).

In this embodiment, the dedicated button 10A is used as the button (enlargement button) to enlarge display contents, while the dedicated button 10B is used as the button (reduction button) to reduce the display contents.

When the enlargement button 10A or the reduction button 10B is pressed, an event notification associated with that button operation is issued by the keyboard/embedded controller 19 to the CPU 11.

If, when the enlargement button 10A or the reduction button 10B is pressed, the subject (the area pointed to by the mouse cursor) the display form of which is to be changed (here enlargement or reduction) is the active window displayed on the display device 121, the display contents within the active window will be displayed with enlargement or reduction. If, on the other hand, the subject of change is the desktop outside the active window, then icons on an image of the desktop become subjects of change and are displayed with enlargement or reduction. This procedure will be described later.

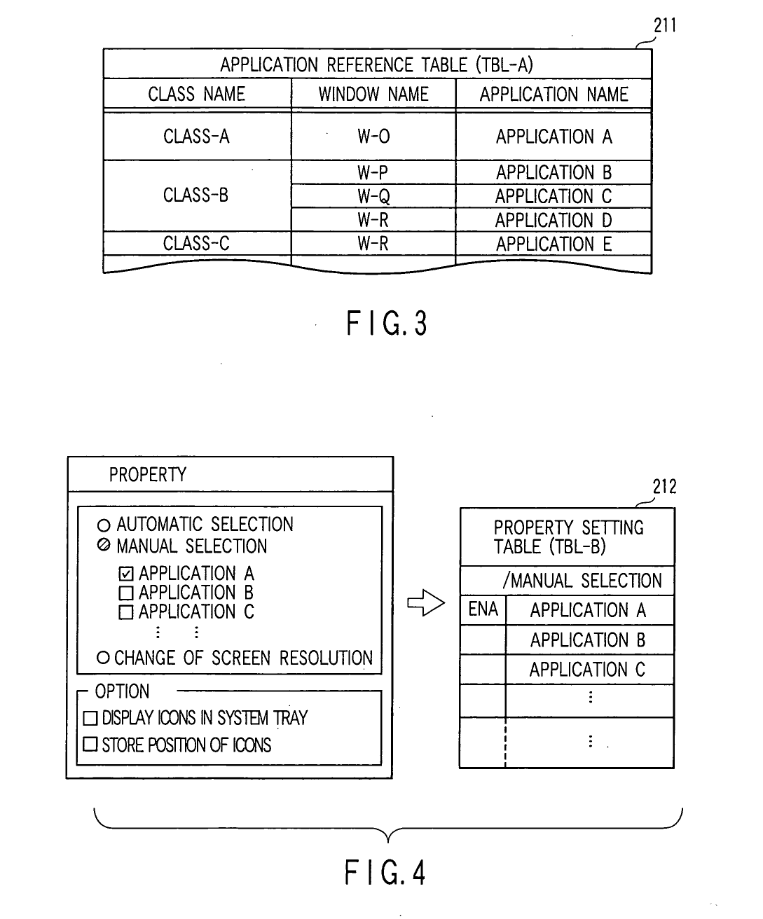

The CPU 11, which is adapted to control the operation of the computer system, carries out various processes in accordance with the operating system (OS), application programs and utility programs which have been loaded from the hard disk drive 17 into the main memory 13. In this embodiment, the CPU 11 carries out enlargement/reduction processing on various windows including the desktop in accordance with a zooming utility program (ZUP) 201 related to a display. The enlargement/reduction processing will be described later with reference to FIGS. 3 through 10B.

The memory 13 is loaded with the zooming utility program (ZUP) 201, an application reference table (TBL-A) 211, a zooming-utility-related property setting table (TBL-B) 212, and a zooming activation table (TBL-C) 213, these tables being referred to by the zooming utility program 201. The memory 13 further stores a registry group 202 having setting information for various windows including the desktop. The zooming utility program 201 is loaded at the time of system activation from the hard disk drive 17. The configurations of the application reference table (TBL-A) 211, the property setting table (TBL-B) 212 for zooming utility program and the zooming activation table (TBL-C) 213 will be described later with reference to FIGS. 3 to 5.

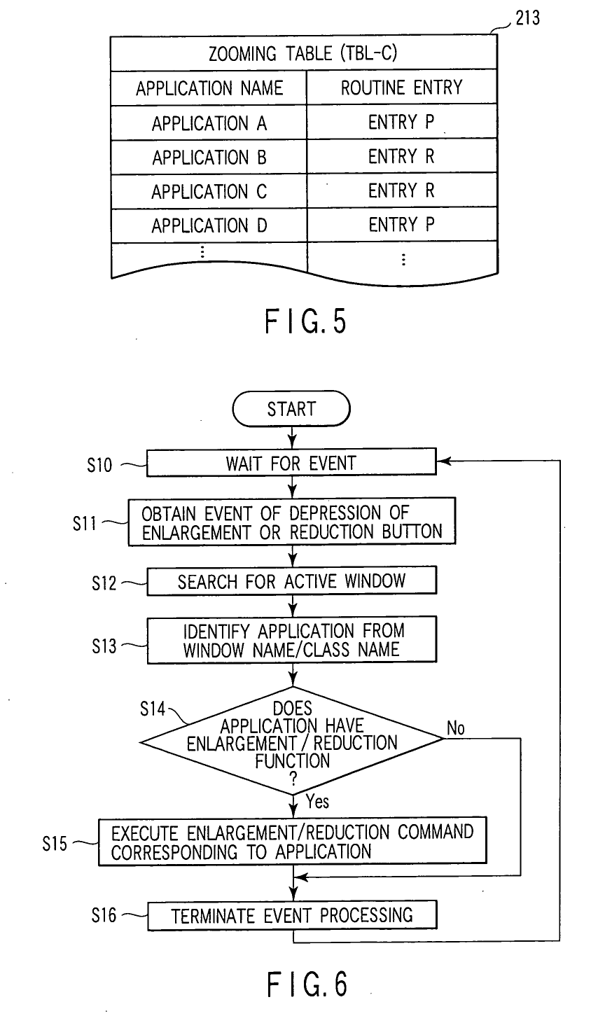

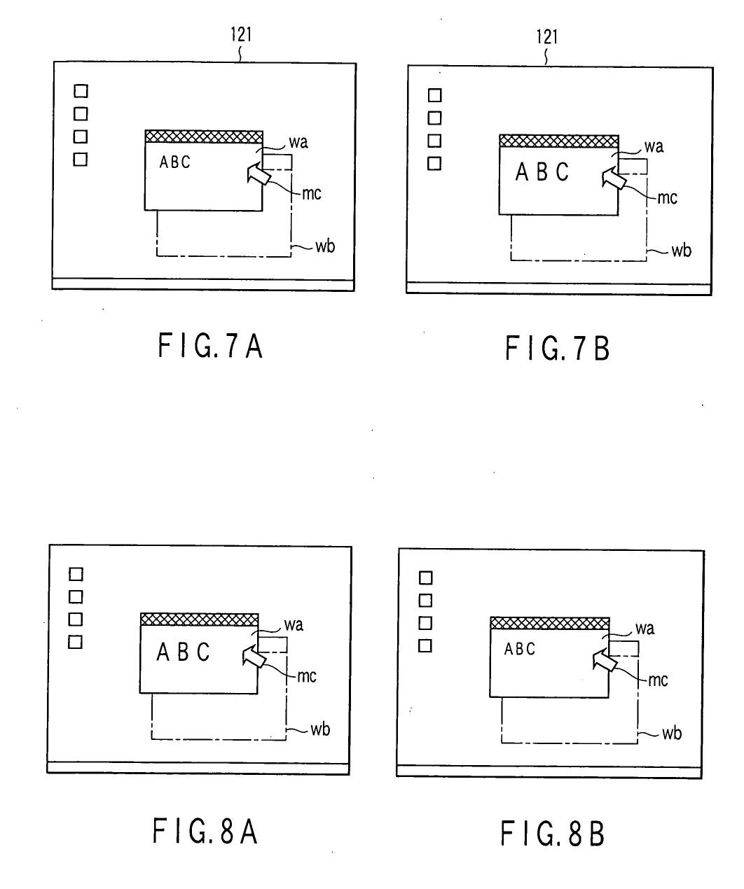

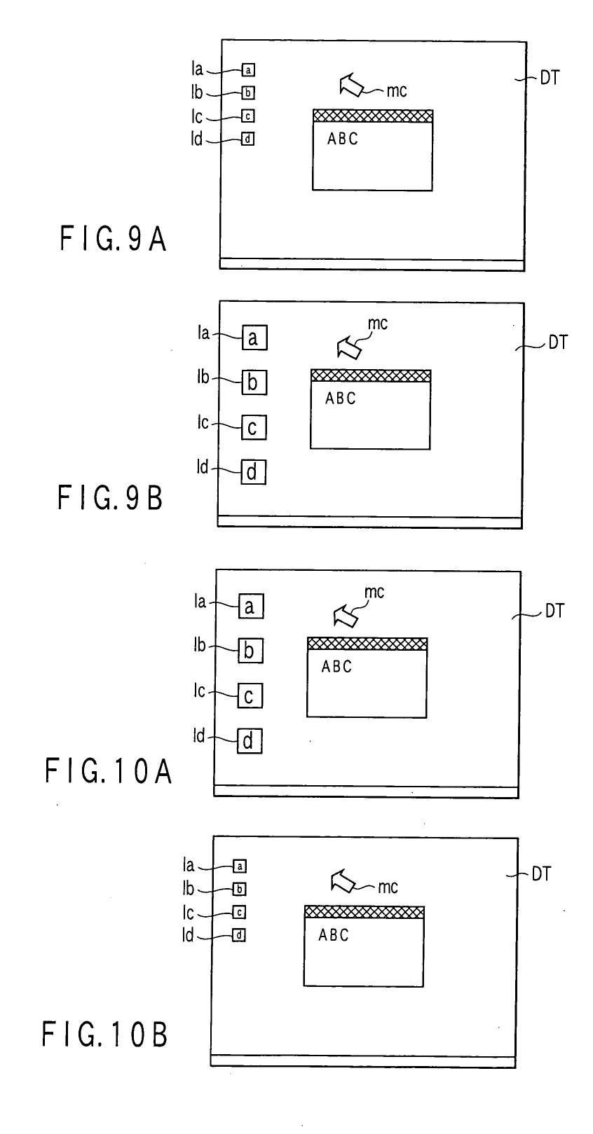

By referring to the application reference table (TBL-A) 211, the zooming-utility-related property setting table (TBL-B) 212, and the zooming activation table (TBL-C) 213, the zooming utility program 201 performs a process of enlarging or reducing the contents of a window as shown in FIGS. 7A through 8B or a process of enlarging or reducing icons on an image of the desktop as shown in FIGS. 9A through 10B, in accordance with such a display control procedure as shown in FIG. 6. In this process, font sizes and so on contained in the registry group 202 and pertaining to the display of the active window the display form of which is to be changed (enlarged/reduced) or the icons on an image of the desktop are rewritten, whereby the contents of the active window or the icons on an image of the desktop are displayed with enlargement or reduction. This enlarging/reducing function (zooming function) will be described later.

The graphics controller 14, under the control of the operating system (OS) executed by the CPU 11, controls the display device 121 and external display devices connected through external display connection interfaces, such as a CRT terminal, a DVI terminal, a TV terminal, etc., which are not shown.

The keyboard/embedded controller (EC/KBC) 19, which is an integrated-circuit device including a microprocessor that provides system power management, the function of the keyboard controller, etc., processes key entries from the keyboard 20, the enlargement button 10A, and the reduction button 10B. When the enlargement button 10A or the reduction button 10B is pressed, the keyboard/embedded controller 19 presents a display control command associated with that operation to the CPU 11. Upon receiving this command from the keyboard/embedded controller 19, the CPU 11 carries out the zooming utility program 201 whose flowchart is shown in FIG. 6.

FIG. 2 is a perspective exterior view of the data processing apparatus. Here, the data processing apparatus is shown in the form of a notebook personal computer by way of example.

The personal computer is composed of a computer body 1 and a display unit (casing in which the LCD display is housed) 2.

The computer body 1 has a casing in the form of a thin box. The keyboard 20 is placed on the top of the casing. A palm rest is formed on the top of the casing in front of the keyboard 20. A touch panel 4 is provided substantially in the central portion of the palm rest. The casing is provided on top with an operation member 5 between the keyboard 20 and the pivoted member that rotatably supports the display unit 2. The operation member 5 includes the enlargement button 10A and the reduction button 10B. As the display device 121, an LCD-based display is built into the display unit 12. The display unit 2 is pivotally mounted to the computer body 1 so that it can rotate between open and closed positions.

FIGS. 3 to 5 show exemplary contents of the respective tables referred to by the zooming utility program 201.

FIG. 3 shows the contents of the application reference table (TBL-A) 211. Here, for various applications (programs) the system can handle, class names, window names and application names are entered into the table in such a way that they are associated with one another. By referring to the application reference table (TBL-A) 211, an application can be identified through a class name or a combination of a class name and a window name.

The contents set on a property screen concerning the zooming utility program and shown in FIG. 4 are entered into the property setting table (TBL-B) 212 as shown in FIG. 4. On the property screen concerning the zooming utility program and shown in FIG. 4, each item shown can be set in accordance with an operating procedure similar to that for setting mouse property by way of example. In this example, automatic/manual setting of the zooming utility program, setting of object applications under the manual setting, display setting of corresponding property icons on the system tray, and setting of icon display positions on the desk top before changing are possible. These settings are held in the property setting table (TBL-B) 212 shown in FIG. 4. It is only applications having the zooming function (zooming routine) that can be set in the table. Applications with no zooming function are removed from candidates for retrieval at the time of manual setting.

FIG. 5 shows the contents of the zooming activation table (TBL-C) 213. Into this table, applications the system can handle are mapped into entry points for calling enlargement/reduction routines (zooming functions) of the respective applications are entered. By referring to the zooming activation table (TBL-C) 213, the zooming function (zooming routine) of a particular application can be called.

FIG. 6 is a flowchart illustrating the procedure of the zooming utility program 201. This program is started each time the enlargement button 10A or the reduction button 10B is pressed. FIGS. 7A through 10B show display examples associated with the zooming function. More specifically, FIGS. 7A and 7B show display examples of enlarging the contents of the active window. FIGS. 8A and 8B show display examples of reducing the contents of the active window. FIGS. 9A and 9B show display examples of enlarging the icons on an image of the desktop in processing performed on an image of the desktop. FIGS. 10A and 10B show display examples of reducing the icons on an image of the desktop in processing performed on an image of the desktop.

When the enlargement button 10A or the reduction button 10B on the computer body 1 is pressed after the computer system shown in FIG. 1 has been activated, the keyboard/embedded controller 19 notifies the CPU 11 of the occurrence of an event associated with that button pressing (step S10 in FIG. 6). Upon receipt of notification of the occurrence of an event associated with-the button pressing from the keyboard/embedded controller 19 (step S11), according to the zooming utility program 201 stored in the memory 13 the CPU 11 searches for a window that is active (step S12), identifies the application that has that active window (step S13) and, when the application has the enlarging/reducing function (YES in step S14), performs a zooming process corresponding to the pressed button on the window in the active state (step S15). Various processes of changing display forms at this point will be described with reference to FIGS. 7A through 10B.

The operation and processing of displaying the contents of the active window with enlargement will be described with reference to FIGS. 7A and 7B.

To select a window and enlarge its contents on the display screen of the display device 121, a window (wa) to be enlarged is clicked on with the mouse cursor (mc) put on that window to make it active and the enlargement button 10A on the top of the computer body 1 pressed. The keyboard/embedded controller 19 notifies the CPU 11 of the occurrence of an event associated with the button pressing (step S10 in FIG. 6).

Upon receipt of notification of the occurrence of an event associated with the button pressing from the keyboard/embedded controller 19 (step S11), the CPU 11 searches- for a window (wa) that is active (step S12). The CPU then obtains the class name or the class and window names of that window (wa) and refers to the application reference table (TBL-A) 211 on the basis of the obtained information to thereby identify the application name corresponding to the window in the active state (step S13).

Then, reference is made to the property setting table (TBL-B) 212 concerning zooming utility program to make a decision of whether or not the identified application in one that accommodates zooming (step S14).

If the application is one capable of zooming (Yes in step S14), then reference is made to the zooming activation table (TBL-C) 213 to call the zooming function (zooming routine) of the application. As a result, a zooming process corresponding to the enlargement button 10A is carried out (step S15). For example, each time the enlargement button 10A is pressed, the display size information in the registry corresponding to the active window (wa) is updated to enlarge the displayed contents stepwise or by a fixed ratio. An example of an enlarged display of the contents of the active window is illustrated in FIG. 7B.

In the event that the identified application is one which has no zooming function (zooming routine) (No in step S14), the pressing of the enlargement button 10A or the reduction button 10B is nullified to terminate the event associated with the button pressing (step S16).

Thus, merely pressing the enlargement button 10A allows the contents of an arbitrary window to be easily displayed with enlargement.

Next, the operation and processing involved in reducing the contents of the active window will be described with reference to FIGS. 8A and 8B.

To select a window and reduce its contents on the display screen of the display device 121, a window (wa) to be enlarged is clicked on with the mouse cursor (mc) put on that window to make it active and the reduction button 10B on the top of the computer body 1 pressed. The keyboard/embedded controller 19 notifies the CPU 11 of the occurrence of an event associated with the button pressing (step S10 in FIG. 6).

Upon receipt of notification of the occurrence of an event associated with the button pressing from the keyboard/embedded controller 19 (step S11), the CPU 11 searches for a window (wa) that is active (step S12). The CPU then obtains the class name or the class and window names of that window (wa) and refers to the application reference table (TBL-A) 211 on the basis of the obtained information to thereby identify the application name corresponding to the window in the active state (step S13).

Then, reference is made to the property setting table (TBL-B) 212 to make a decision of whether or not the identified application is one that accommodates zooming (step S14).

If the application is one capable of zooming (Yes in step S14), then reference is made to the zooming activation table (TBL-C) 213 to call the zooming function (zooming routine) of the identified application. As a result, a zooming process corresponding to the reduction button 10B is carried out (step S15). For example, each time the reduction button 10B is pressed, the display size information in the registry corresponding to the active window (wa) is updated to reduce the displayed contents stepwise or by a fixed ratio. An example of a reduced display of the contents of the active window is illustrated in FIG. 8B.

In the event that the identified application is one which has no zooming function (zooming routine) (No in step S14), the pressing of the enlargement button 10A or the reduction button 10B is nullified to terminate the event associated with the button pressing (step S16).

Thus, merely pressing the reduction button 10B allows the contents of an arbitrary window to be easily displayed with reduction.

Reference is next made to FIGS. 9A through 10B to describe the operation and processing of enlarging/reducing the contents of a window with regard to the desktop. In this embodiment, the desktop is also considered a window which becomes a subject of enlargement or reduction processing. When the enlargement button 10A is pressed, icons on an image of the desktop are enlarged in size by a fixed ratio. When the reduction button 10B is pressed, on the other hand, the icons are reduced in size by a fixed ratio.

Reference is now made to FIGS. 9A and 9B to describe the operation and processing of enlarging the icons on an image of the desktop.

On the display screen of the display device 121 shown in FIG. 9A, the user clicks on an image of the desktop (DT) with the mouse cursor (mc) put on an image of the desktop to make it active and then presses the enlargement button 10A. The keyboard/embedded controller 19 notifies the CPU 11 of the occurrence of an event associated with the button pressing (step S10 in FIG. 6). Upon receipt of notification of the occurrence of an event associated with the button pressing from the keyboard/embedded controller 19 (step S11), the CPU 11 searches for the active window (wa) pointed to by the mouse cursor (mc) (step S12) and identifies it (step S13). Here, the active window is the desktop (DT) configured such that icons can be enlarged or reduced in size (Yes in step S14). Therefore, the display size held in the registry for icons (Ia, Ib, . . . ) on an image of the desktop is changed by a fixed enlargement ratio with the result that the icons are displayed with enlargement (step S15). An enlargement display of the icons on an image of the desktop is illustrated in FIG. 9B.

Thus, merely pressing the enlargement button 10A allows the icons (Ia, Ib, . . . ) on an image of the desktop (DT) to be easily displayed with enlargement.

Reference is next made to FIGS. 10A and 10B to describe the operation and processing of reducing the icons on an image of the desktop.

On the display screen of the display device 121 shown in FIG. 10A, the user clicks on an image of the desktop (DT) with the mouse cursor (mc) put on an image of the desktop to make it active and then presses the reduction button 10B. The keyboard/embedded controller 19 notifies the CPU 11 of the occurrence of an event associated with the button pressing (step S10 in FIG. 6). Upon receipt of notification of the occurrence of an event associated with the button pressing from the keyboard/embedded controller 19 (step S11), the CPU 11 searches for the active window (wa) pointed to by the mouse cursor (mc) (step S12) and identifies it (step S13). Here, the active window is the desktop (DT) configured such that icons can be enlarged or reduced in size (Yes in step S14). Therefore, the display size held in the registry for icons (Ia, Ib, . . . ) on an image of the desktop is changed by a fixed reduction ratio with the result that the icons are displayed with reduction (step S15). A reduction display of the icons on an image of the desktop is illustrated in FIG. 10B.

Thus, merely pressing the reduction button 10B allows the icons (Ia, Ib, . . . ) on an image of the desktop (DT) to be easily displayed with reduction.

According to the present embodiment, manipulating operation member assigned predetermined functions allows a window in the active state to be searched for and only images within the active window (of the multiple windows appearing on screen, the window appearing in front of the others) to be displayed with enlargement or reduction through processing function of changing the display form of the searched window. Moreover, the use of single operation member allows either images on an image of the desktop or images within the active window to be selectively displayed with enlargement or reduction.

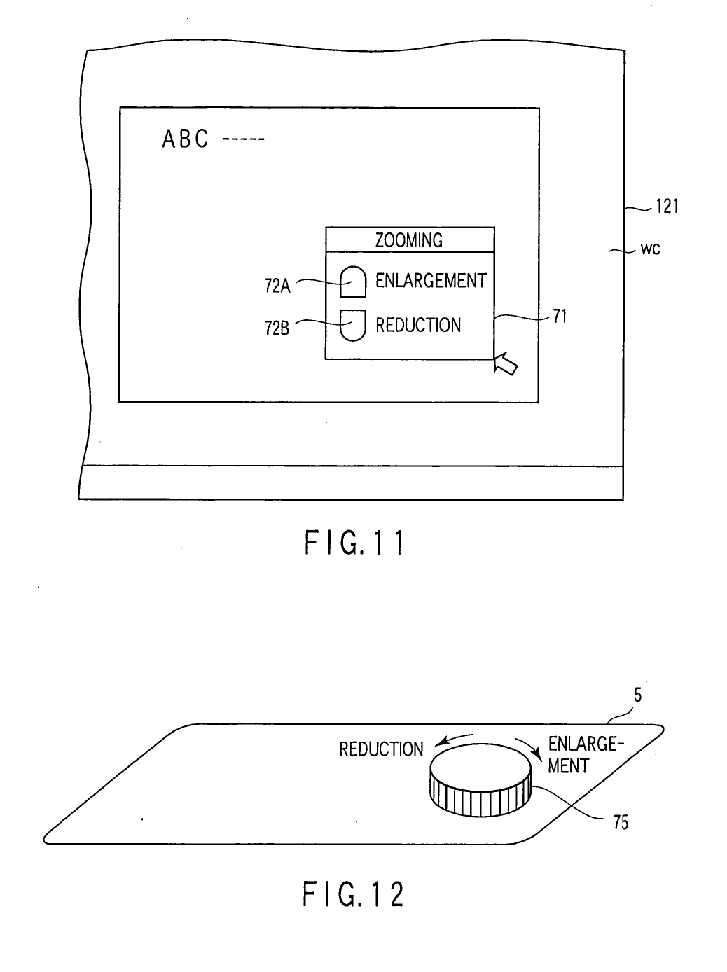

Although the embodiment has been described as using the enlargement button 10A or the reduction button 10B mounted to the top of the computer body 1 to display the contents of the active window or the icons on an image of the desktop with enlargement or reduction, this is not restrictive. Other operation member than the enlargement and reduction buttons 10A and 10B may be used. For example, it is also possible to cause such an enlargement/reduction operating window 71 as shown in FIG. 11 to appear by clicking the right-hand button of the mouse on the inside of the active window (wc) or on an image of the desktop and then click an enlargement button 72A or a reduction button 72B within that window 71. By doing so, the contents of the active window or the icons on an image of the desktop can be displayed with enlargement or reduction as in the embodiment. Alternatively, as shown in FIG. 12, an enlargement/reduction dial 75 may be provided on the operation member 5 on the top of the computer body in place of the enlargement button 72A and the reduction button 72B. In this case, it will become possible to continuously enlarge or reduce the contents of the active window or the icons on an image of the desktop. Further, the functions of the enlargement button 10A and the reduction button 10B may be assigned to specific individual keys or combinations of specific keys on the keyboard 20.

The embodiment has been described in terms of processing of enlarging or reducing the contents of the active window or the icons on an image of the desktop through the use of the enlargement button 10A or the reduction button 10B. For applications having a display processing function (processing routine) other than the zooming function, the enlargement button 10A and the reduction button 10B may be used to perform that display processing function.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A data processing apparatus comprising:
an operation member which is operated to change a display form of displayed contents; and
a processing unit which is responsive to an operation of the operation member to change the display form of the displayed contents of an active window.

2. The data processing apparatus according to claim 1, wherein the operation member is operated to enlarge or reduce the displayed contents of the window.

3. The data processing apparatus according to claim 2, wherein the processing unit enlarges or reduces the displayed contents of the window stepwise.

4. The data processing apparatus according to claim 2, wherein the processing unit enlarges or reduces the displayed contents of the window by a predetermined ratio.

5. The data processing apparatus according to claim 1, wherein the processing unit makes a decision of whether or not the display function of an application in the active window supports the change of the display form commanded by the operation member and, when supported, performs the function.

6. The data processing apparatus according to claim 5, wherein the display function of the application includes a function of enlarging or reducing images.

7. The data processing apparatus according to claim 2, wherein the operation member includes an operating button dedicated for enlargement or reduction.

8. The data processing apparatus according to claim 2, wherein the operation member includes an operating dial dedicated for enlargement or reduction.

9. The data processing apparatus according to claim 2, wherein the operation member includes a specific key provided on a keyboard.

10. The data processing apparatus according to claim 1, wherein the operation member is assigned a predetermined display function, and the processing unit includes a unit which obtains an event associated with an operation of the operation member, a unit which searches for an active window in accordance with the obtained event, a unit which identifies an application from the class name or the window name including the class name of the searched window, and a unit which makes a decision of whether or not the identified application is capable of carrying out the display function assigned to the operation member and, when the decision is that it is capable, carries out the display function.

11. A data processing apparatus comprising:
a display unit having a screen capable of displaying windows;
an operation member which is operated to change a display form; and
a processing unit which is responsive to an operation of the operation member to search through the windows displayed on the screen for a window in an active state and changes the display form of displayed contents of the searched window.

12. A data processing apparatus comprising:
a display unit on which an image of a desktop appears;
an operation member which is operated to change the display form of the image of the desktop; and
a processing unit which is responsive to an operation of the operation member to change the display form of the image of the desktop.

13. The data processing apparatus according to claim 12, wherein the processing unit is responsive to an operation of the operation member to enlarge or reduce icons on an image of the desktop.

14. The data processing apparatus according to claim 13, wherein the operation member includes an operating button dedicated for enlargement or reduction.

15. A display control method comprising:
obtaining an event associated with an operation on an operation member assigned a predetermined function;
detecting an active window in accordance with the obtained event;
identifying an application from the class name or the window name including the class name of the detected window;
making a decision of whether or not the identified application is capable of carrying out a function corresponding to the obtained event; and
carrying out that function when the decision is that the identified application is capable of carrying out that function.

16. The display control method according to claim 15, wherein the function assigned to the operation member is the display enlargement or reduction function, and the step of carrying out the function involves making a decision of whether or not the mouse cursor is present in the active window on an image of the desktop, enlarging or reducing the display contents of the active window in response to an operation of the operation member when the mouse cursor is present in the active window, and enlarging or reducing icons on an image of the desktop in response to an operation of the operation member when the mouse cursor is present outside the active window.
